(19) United States
(12) Patent Application Publication
(10) Pub. No.: US 2008/0240743 A1
(43) Pub. Date: Oct. 2, 2008

(54) Sheet-conveying apparatus and method for detection of multiple-sheet feeding thereof

(75) Inventors: Yen-Cheng Chen, Hsinchu (TW); Jen-Chien Chang, Yilan (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/007,294

(22) Filed: Jan. 9, 2008

(30) Foreign Application Priority Data
Apr. 2, 2007 (TW) 96111679

(51) Int. Cl. G03G 15/00

(52) U.S. Cl. 399/16

(57) ABSTRACT

A sheet-conveying apparatus and a method for detecting multiple-sheet feeding thereof are provided. The sheet-conveying apparatus includes a passageway, a sheet-transporting mechanism and a sheet-detecting device. The sheet-detecting device includes a first transmitter, a first receiver, a second transmitter and a second receiver. The first receiver is for receiving a first signal of a first intensity transmitted from the first transmitter. The second receiver is for receiving a second signal of a second intensity transmitted from the second transmitter. The second intensity of the second signal is not equal to the first intensity of the first signal. The sheet-detecting device further includes an analysis unit for determining if the multiple sheets are conveyed in the passageway, according to the intensities of the signals respectively received by the first receiver and the second receiver.

This application claims the benefit of Taiwan application Serial No. 96111679, filed Apr. 2, 2007 the subject matter of which is incorporated herein by reference.

### BACKGROUND OF THE INVENTION

1. Field of the Invention

The invention relates in general to a sheet-conveying apparatus, and more particularly to a sheet-conveying apparatus capable of detecting multiple-sheet feeding.

2. Description of the Related Art

Currently, the printers, scanners, copiers, multi-functional machines or plotters, for home use as well as for business use, are equipped with a sheet-conveying apparatus such as an automatic sheet feeder (ADF) and do not require the user to feed in sheets manually. The sheet-conveying apparatus feeds the sheets, which are placed in a document tray, into the above electronic device one by one. Not until a sheet is completely fed into the electronic device will the electronic device perform the subsequent operation of scanning, printing or plotting.

Despite the current sheet-sorting technology of the sheet-conveying apparatus which can effectively convey the sheet one by one, the problem of having multiple sheets fed at the same time still occurs during the transporting of the sheets. For example, when scanning a stack of sheets, if the user does not notice that multiple sheets are fed at the same time, the information contents of the overlapping sheets will be missed out. Also, during the copying process, paper jam would occur easily, which forces the user to stop the current operation, if multiple sheets are fed into the electronic device at the same time. The operation of the electronic device cannot resume unless the paper jam problem is resolved.

Therefore, how to effectively detect the feeding of sheets during sheet-conveying process is an important issue to be solved.

### SUMMARY OF THE INVENTION

The invention is directed to a sheet-conveying apparatus and a method for detecting multiple-sheet feeding thereof. At least two sets of transmitter and receiver are used in the sheet-conveying apparatus, and the intensities of the signals transmitted from the two transmitters are different so that better detecting effect is achieved.

According to a first aspect of the present invention, a sheet-conveying apparatus including a passageway, a sheet-transporting mechanism and a sheet-detecting device is provided. The sheet-detecting device includes a first transmitter, a first receiver, a second transmitter and a second receiver. The first receiver is for receiving a first signal of a first intensity transmitted from the first transmitter. The second receiver is for receiving a second signal of a second intensity transmitted from the second transmitter. The second intensity of the second signal is not equal to the first intensity of the first signal.

According to a second aspect of the present invention, a method for detecting if more than one sheet is conveyed in a sheet-conveying apparatus is provided. The method includes the following steps. A first signal of a first intensity is transmitted from a first transmitter. The first signal is received by a first receiver. A second signal of a second intensity that is not equal to the first intensity is transmitted from a second transmitter.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of a sheet-conveying apparatus according to a preferred embodiment of the invention; and

FIG. 2 is a flowchart of a method for detecting multiple-sheet feeding of the sheet-conveying apparatus of FIG. 1.

### DETAILED DESCRIPTION OF THE INVENTION

The present embodiment of the invention provides a sheet-conveying apparatus and a method for detecting multiple-sheet feeding thereof. The sheet-conveying apparatus uses a sheet-detecting device to detect if multiple sheets are conveyed by the sheet-conveying apparatus.

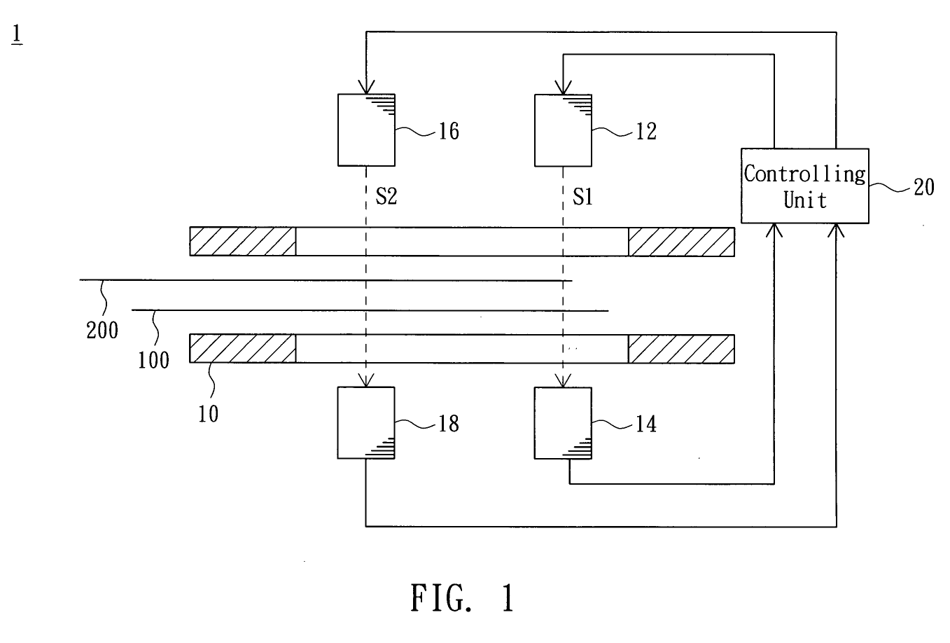

Referring to FIG. 1, a perspective of a sheet-conveying apparatus according to a preferred embodiment of the invention is shown. As indicated in FIG. 1, the sheet-conveying apparatus 1 includes a passageway 10 for a sheet to pass through, a sheet-transporting mechanism (not illustrated) for conveying the sheet to pass through the passageway 10, and a sheet-detecting device disposed in the passageway 10. The sheet-detecting device includes a first transmitter 12, a first receiver 14, a second transmitter 16, a second receiver 18 and a controlling unit 20. The first receiver 14 receives a first signal S1 transmitted from the first transmitter 12. The second receiver 18 receives a second signal S2 transmitted from the second transmitter 16. The intensity of the second signal S2 transmitted from the second transmitter 16 is not equal to the intensity of the first signal S1 transmitted from the first transmitter 12.

The transmitters and receivers are respectively disposed on two sides of the passageway 10. In the present embodiment of the invention, the first transmitter 12 and the first receiver 14 are disposed on two opposite sides of the passageway 10, and the second transmitter 16 and the second receiver 18 are also disposed on two opposite sides of the passageway 10.

Preferably, the first transmitter 12 and the second transmitter 16 are ultrasonic transducers. In addition, the first receiver 14 and the second receiver 18, which respectively correspond to the first transmitter 12 and the second transmitter 16, are capable of receiving ultrasonic signals.

The controlling unit 20 is electrically connected to the first transmitter 12, the first receiver 14, the second transmitter 16 and the second receiver 18. The controlling unit 20 can control the first transmitter 12 and the second transmitter 16 to transmit signals. The controlling unit 20 includes an analysis unit (not illustrated) for analyzing the signals transmitted from the first receiver 14 and the second receiver 18 so as to determine if multiple sheets are conveyed in the sheet-conveying apparatus 1.

The present embodiment of the invention is exemplified by two sets of transmitters and the receivers; however, in other embodiments, more than two sets of transmitters and receivers can be used. Multiple sets of transmitters and receivers for transmitting and receiving signals of different intensities are capable of detecting sheets of different weights, so that the sheet-conveying apparatus 1 is able to precisely detect the multiple sheets conveyed in the sheet-conveying apparatus 1. In the present embodiment of the invention, the first transmitter 12 and the first receiver 14 are for detecting a first-type sheet, and the second transmitter 16 and the second receiver 18 are for detecting a second-type sheet. The basis weight of the first-type sheet can be different from that of the second-type sheet. Preferably, the first transmitter 12 transmits the first signal S1 whose intensity is larger than that of the second signal S2 transmitted from the second transmitter 16 so as to detect the first-type sheet whose basis weight is greater than that of the second-type sheet. For example, the first transmitter 12 and the first receiver 14 are used to detect a sheet whose basis weight ranges from 60 to 150 g/m², and the second transmitter 16 and the second receiver 18 are used to detect a sheet whose basis weight ranges from 30 to 60 g/m². Thus, the sheet-conveying apparatus 1 of the present embodiment of the invention is capable of detecting sheets of different weights.

The sheet-transporting mechanism feeds the sheets into the passageway 10 of the sheet-conveying apparatus 1 one by one. As illustrated in FIG. 1, when a sheet 100 and a sheet 200 are fed into the passageway 10 at the same time, the sheet-feeding condition in the sheet-conveying apparatus 1 can be detected through the first transmitter 12, the first receiver 14, the second transmitter 16, the second receiver 18 and the controlling unit 20. A method for detecting multiple-sheet feeding is disclosed in the present embodiment of the invention with accompanied drawings.

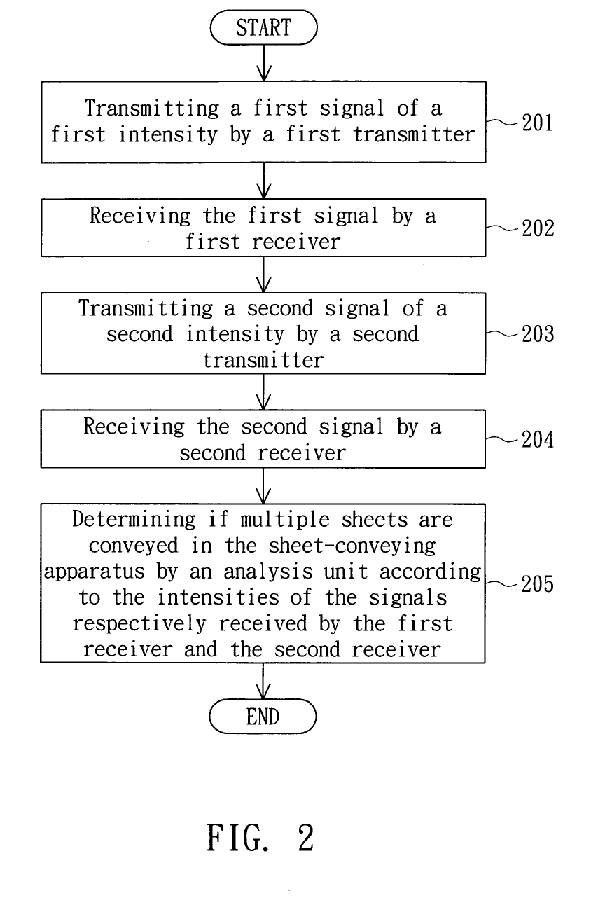

Referring to FIG. 2, a flowchart of a method for detecting multiple-sheet feeding of the sheet-conveying apparatus of FIG. 1 is shown. As indicated in FIG. 2, the method for detection of multiple-sheet feeding of the sheet-conveying apparatus 1 includes steps 201 to 205 stated below. A first signal of a first intensity is transmitted from a first transmitter and received by a first receiver. A second signal of a second intensity is transmitted from a second transmitter and received by a second receiver. The second intensity of the second signal is not equal to the first intensity of the first signal. Then, whether multiple sheets are conveyed in the sheet-conveying apparatus is determined according to the intensities of the signals respectively received by the first receiver and the second receiver.

In steps 201 to 204, as the sheet-conveying apparatus 1 begins to convey a sheet, the driving circuit (not illustrated) inside the controlling unit 20 controls the first transmitter 12 and the second transmitter 16 to transmit the first signal S1 and the second signal S2 (both are ultrasonic signal). The first signal S1 and the second signal S2 passing through the sheet 100 and the sheet 200 are received by the first receiver 14 and the second receiver 18, respectively. The transmission of the ultrasonic signals is related to the medium in transmission. When the ultrasonic signals pass through a sheet, the sheet generates an absorption-like effect on the ultrasonic signals. Thus, compared with the original signals transmitted from the first transmitter 12 and the second transmitter 16, the intensities of the signals received by the first receiver 14 and the second receiver 18 are different from the first intensity and the second intensity.

In an alternate embodiment, the first transmitter 12 and the second transmitter 16 can transmit signals of different intensities either at the same time or at different times.

In step 205, the signals received by the first receiver 14 and the second receiver 18 are analyzed and processed by an analog circuit, a digital-to-analog converter and a digital circuit so as to obtain signal attenuation or a phase shift, thereby determining if multiple sheets are conveyed in the sheet-conveying apparatus 1. If so, the controlling unit 20 continues its functioning to other subsequent processing step.

Electronic devices such as scanners, copiers and multi-functional peripherals can be equipped with a sheet-conveying apparatus 1, which is capable of detecting multiple-sheet feeding in order to avoid paper jam when too many sheets are loaded into the passageway of the sheet-conveying apparatus. The subsequent processing steps after more than one sheet is detected are stated below.

1. The electronic device will stop current operation or directly convey the overlapping sheets to the sheet-out tray. If the electronic device has a control panel or screen, the message that multiple sheets are conveyed at the same time is displayed on the control panel or the screen.

2. Take a scanner for example. When more than one sheet is fed in, the scanner continues to scan the fed-in sheets, but only the one sheet that is placed closest to an image capturing module of the scanner will be scanned. After the scanning is completed, the message that multiple sheets are conveyed will also be displayed on the control panel or the screen.

A sheet-conveying apparatus and a method for detecting multiple-sheet feeding thereof are disclosed in the above embodiment of the invention. A sheet-detecting device having at least two sets of transmitters and receivers is used in the sheet-conveying apparatus. During the sheet conveying process, ultrasonic signals of different intensities are transmitted from the transmitters. Whether multiple sheets are conveyed in the sheet-conveying apparatus is determined according to the attenuation or the phase shift of the ultrasonic signals. Moreover, the sheet-conveying apparatus, transmitting ultrasonic signals of different intensities, of the invention is capable of detecting sheets having different basis weight. The sheet-conveying apparatus of the invention is applicable to electronic devices such as copiers, scanners and multifunctional peripherals.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sheet-conveying apparatus, comprising:
a passageway for a sheet to pass through;
a sheet-transporting mechanism for conveying the sheet to pass through the passageway; and
a sheet-detecting device disposed in the passageway, having:
a first transmitter for transmitting a first signal of a first intensity;
a first receiver for receiving the first signal;
a second transmitter for transmitting a second signal of a second intensity, wherein the second intensity is not equal to the first intensity; and
a second receiver for receiving the second signal.

2. The sheet-conveying apparatus according to claim 1, wherein the sheet-detecting device further comprises an analysis unit connected to the first receiver and the second receiver for determining if multiple sheets are conveyed in the passageway, according to the intensities of the signals respectively received by the first receiver and the second receiver.

3. The sheet-conveying apparatus according to claim 1, wherein the first signal transmitter and the second transmitter are ultrasonic transducers.

4. The sheet-conveying apparatus according to claim 1, wherein the first transmitter and the first receiver detect a first-type sheet, the second transmitter and the second receiver detect a second-type sheet, and the basis weight of the first-type sheet is different from the basis weight of the second-type sheet.

5. The sheet-conveying apparatus according to claim 4, wherein the first intensity of the first signal is larger than the second intensity of the second signal, and the basis weight of the first-type sheet is greater than the basis weight of the second-type sheet.

6. The sheet-conveying apparatus according to claim 1, wherein the first transmitter and the second transmitter transmit signals at the same time.

7. The sheet-conveying apparatus according to claim 1, wherein the first transmitter and the second transmitter transmit signals at different times.

8. A method for detecting if more than one sheet is conveyed in a sheet-conveying apparatus, the method comprising:
transmitting a first signal of a first intensity by a first transmitter;
receiving the first signal by a first receiver;
transmitting a second signal of a second intensity by a second transmitter, wherein the second intensity is not equal to the first intensity; and
receiving the second signal by a second receiver.

9. The method according to claim 8, further comprising:
determining if multiple sheets are conveyed in the sheet-conveying apparatus by an analysis unit, according to the intensities of the signals respectively received by the first receiver and the second receiver.

10. The method according to claim 8, wherein the first signal and the second signal respectively transmitted from the first transmitter and the second transmitter are ultrasonic signals.

11. The method according to claim 8, comprises:
transmitting the first signal by the first transmitter to detect a first-type sheet; and
transmitting the second signal by the second transmitter to detect a second-type sheet, wherein the basis weight of the first-type sheet is different from that of the second-type sheet.

12. The method according to claim 11, wherein the first intensity of the first signal is larger than the second intensity of the second signal, and the basis weight of the first-type sheet is greater than that of the second-type sheet.

13. The method according to claim 8, comprises:
transmitting the signals by the first transmitter and the second transmitter at the same time.

14. The method according to claim 8, comprises:
transmitting the signals by the first transmitter and the second transmitter at different times.
